(19) United States
(12) Patent Application Publication
(10) Pub. No.: US 2025/0068370 A1
(43) Pub. Date: Feb. 27, 2025

(54) INFORMATION PROCESSING DEVICE, AND CONTROL METHOD

(71) Applicant: Mitsubishi Electric Corporation, Tokyo (JP)

(72) Inventor: Yasushi SUGAMA, Tokyo (JP)

(73) Assignee: Mitsubishi Electric Corporation, Tokyo (JP)

(21) Appl. No.: 18/947,861

(22) Filed: Nov. 14, 2024

Related U.S. Application Data
(63) Continuation of application No. PCT/JP2022/028383, filed on Jul. 21, 2022.

(51) Int. Cl. G06F 3/14

(52) U.S. Cl. CPC G06F 3/14

(57) ABSTRACT

An information processing device executes communication with a display device. The information processing device includes an acquisition unit that acquires ratio information that indicates a ratio of each attribute corresponding to a plurality of users existing in a vicinity of the display device and a facility table indicating correspondence relationship between content and an attribute, an identification unit that identifies one attribute based on ordinal ranks corresponding to the ratio of each attribute and identifies content corresponding to the identified attribute based on the facility table, and a control unit that executes control for making the display device display the identified content.

### CROSS-REFERENCE TO RELATED APPLICATION

This application is a continuation application of International Application No. PCT/JP2022/028383 having an international filing date of Jul. 21, 2022, which is hereby expressly incorporated by reference into the present application.

### BACKGROUND OF THE INVENTION

### 1. Field of the Invention

The present disclosure relates to an information processing device, and a control method.

### 2. Description of the Related Art

It has been known that content is displayed by a display device. For example, a signage displays content. In such a circumstance, there has been proposed a technology for displaying content as an advertisement and a congestion level (see Patent Reference 1). An information display system in the Patent Reference 1 includes a plurality of first display terminals and a plurality of second display terminals. The congestion level is displayed by the first display terminals. The advertisement is displayed by the second display terminals.

Patent Reference 1: Japanese Patent Application Publication No. 2012-128395

In the above-described technology, each of the plurality of second display terminals displays the content as the advertisement. There are cases where content not attracting interest is included in the displayed content. Providing content not attracting interest is undesirable.

### SUMMARY OF THE INVENTION

An object of the present disclosure is to provide content that attracts interest.

An information processing device according to an aspect of the present disclosure is provided. The information processing device executes communication with a display device. The information processing device includes an acquisition unit that acquires ratio information that indicates a ratio of each attribute corresponding to a plurality of users existing in a vicinity of the display device and facility information indicating correspondence relationship between content and an attribute, an identification unit that identifies one attribute based on ordinal ranks corresponding to the ratio of each attribute and identifies content corresponding to the identified attribute based on the facility information, and a control unit that executes control for making the display device display the identified content.

According to the present disclosure, content that attracts interest can be provided.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing an information provision system in a first embodiment;

FIG. 2 is a diagram showing hardware included in an information processing device in the first embodiment;

FIG. 3 is a block diagram showing functions of the information processing device in the first embodiment;

FIG. 4 is a diagram showing an example of a facility table in the first embodiment;

FIG. 5 is a flowchart showing an example of a process executed by the information processing device in the first embodiment;

FIG. 6 is a diagram showing an information provision system in a second embodiment;

FIG. 7 is a block diagram showing functions of an information processing device in the second embodiment;

FIG. 8 is a diagram showing an example of a usage history table in the second embodiment;

FIG. 9 is a flowchart showing an example of a process executed by the information processing device in the second embodiment;

FIG. 10 is a flowchart showing an example of a process executed by an information processing device in a modification of the second embodiment;

FIG. 11 is a diagram showing an information provision system in a third embodiment;

FIG. 12 is a block diagram showing functions of an information processing device in the third embodiment;

FIG. 13 is a flowchart showing an example of a process executed by the information processing device in the third embodiment;

FIG. 14 is a flowchart showing an example of a process executed by an information processing device in a modification of the third embodiment;

FIG. 15 is a block diagram showing functions of an information processing device in a fourth embodiment; and

FIG. 16 is a diagram showing an example of a guidance effect table in the fourth embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

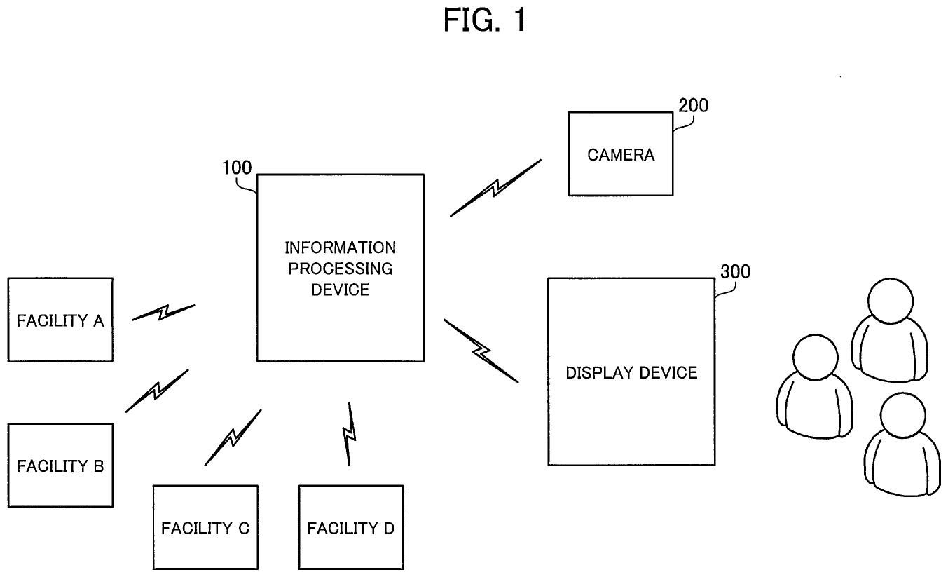

FIG. 1 is a diagram showing an information provision system in a first embodiment. The information provision system includes an information processing device 100, a camera 200 and a display device 300. The information processing device 100, the camera 200 and the display device 300 execute communication via a network. The network is a wired network or a wireless network.

The information processing device 100 is a device that executes a control method. The information processing device 100 is a server, for example.

Further, the information processing device 100 may execute communication with communication devices installed in facilities. For example, the information processing device 100 may execute communication with communication devices installed in facilities A, B, C and D. Four facilities are drawn in FIG. 1. The information processing device 100 may execute communication with communication devices installed in four or more facilities. The information processing device 100 may receive a congestion level of a facility from the communication device installed in the facility.

The camera 200 photographs a plurality of users existing in the vicinity of the display device 300. The display device 300 is a signage, for example.

Next, hardware included in the information processing device 100 will be described below.

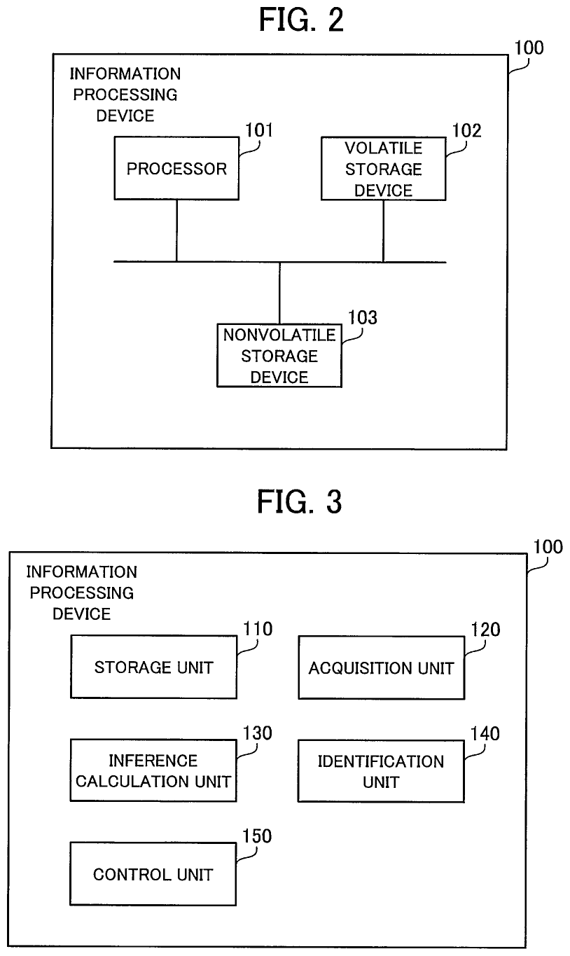

FIG. 2 is a diagram showing the hardware included in the information processing device in the first embodiment. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Next, functions included in the information processing device 100 will be described below.

FIG. 3 is a block diagram showing the functions of the information processing device in the first embodiment. The information processing device 100 includes a storage unit 110, an acquisition unit 120, an inference calculation unit 130, an identification unit 140 and a control unit 150.

The storage unit 110 may be implemented as a storage area reserved in the volatile storage device 102 or the nonvolatile storage device 103.

Part or all of the acquisition unit 120, the inference calculation unit 130, the identification unit 140 and the control unit 150 may be implemented by processing circuitry. Further, part or all of the acquisition unit 120, the inference calculation unit 130, the identification unit 140 and the control unit 150 may be implemented as modules of a program executed by the processor 101. For example, the program executed by the processor 101 is referred to also as a control program. The control program has been recorded in a record medium, for example.

The storage unit 110 may store a facility table. The facility table will be described later.

The acquisition unit 120 may acquire an image obtained by the camera 200 by photographing a plurality of users.

The inference calculation unit 130 infers an attribute of the plurality of users based on the image. For example, the attribute can be sex, age, group or the like. For example, the inference calculation unit 130 infers the attribute of the plurality of users by using image recognition technology.

When a group is inferred, for example, the inference calculation unit 130 infers that a set of users in which the distance between users is short is a group. When a group is inferred, the inference calculation unit 130 may infer that a set of users wearing the same uniforms is a group.

The inference calculation unit 130 infers the number of the plurality of users based on the image. For example, the inference calculation unit 130 infers the number of users (i.e., total number of people) by using image recognition technology.

The inference calculation unit 130 calculates a ratio of each attribute by using the number of people having the inferred attribute and the total number of people. For example, the inference calculation unit 130 calculates the ratio of males based on the number of males and the total number of people. The ratio of each attribute is calculated as above. For example, the ratio of each attribute can be the ratio of males, the ratio of females, the ratio of people in their 20's, the ratio of people in their 30's, the ratio of families, and so forth.

The acquisition unit 120 acquires ratio information indicating the ratio of each attribute. For example, the acquisition unit 120 acquires the ratio information calculated by the inference calculation unit 130. Alternatively, for example, the acquisition unit 120 acquires the ratio information from an external device. The external device is a device having the same function as the inference calculation unit 130. Illustration of the external device is left out.

The identification unit 140 identifies one attribute based on ordinal ranks corresponding to the ratio of each attribute. For example, the identification unit 140 identifies an attribute whose ordinal rank is No. 1. That is, the identification unit 140 identifies an attribute whose ratio is the highest. Alternatively, for example, the identification unit 140 identifies an attribute whose ordinal rank is No. 2. It is desirable for the identification unit 140 to identify an attribute whose ordinal rank is high.

The acquisition unit 120 acquires the facility table. For example, the acquisition unit 120 acquires the facility table from the storage unit 110. Alternatively, for example, the acquisition unit 120 acquires the facility table from the external device. Here, the facility table will be shown below.

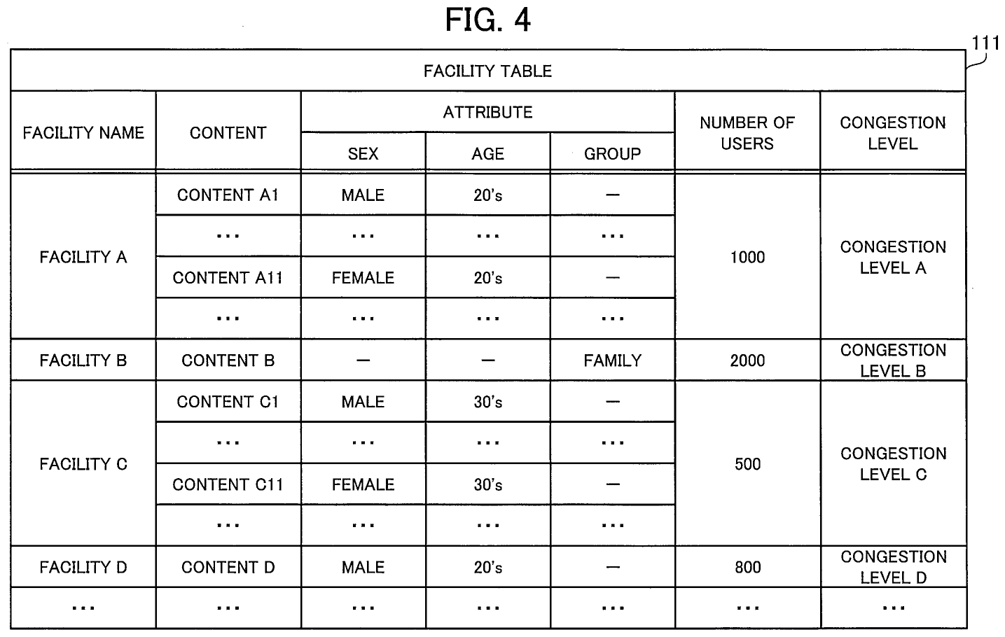

FIG. 4 is a diagram showing an example of the facility table in the first embodiment. For example, the facility table 111 is stored in the storage unit 110. The facility table 111 is referred to also as facility information.

The facility table 111 indicates correspondence relationship among a facility, content, an attribute, number of users and a congestion level of a facility. Specifically, the facility table 111 includes items of facility name, content, attribute, number of users and congestion level. In the item of facility name, the name of a facility is registered. In the item of content, content is registered. In the item of attribute, an attribute is registered. In the item of number of users, the number of people who used the facility is registered. In the item of congestion level, the congestion level received from the communication device installed in the facility is registered.

The identification unit 140 identifies content corresponding to the identified attribute based on the facility table 111. For example, when the identified attribute is male, the identification unit 140 identifies content A1, C1 and D.

The control unit 150 executes control for making the display device 300 display the identified content. Specifically, the control unit 150 transmits the identified content and a display command regarding the content to the display device 300. Accordingly, the display device 300 displays the content. Further, in cases where the display device 300 has stored the identified content, the control unit 150 transmits the display command regarding the content to the display device 300. Accordingly, the display device 300 displays the content.

Next, a process executed by the information processing device 100 will be described below by using a flowchart.

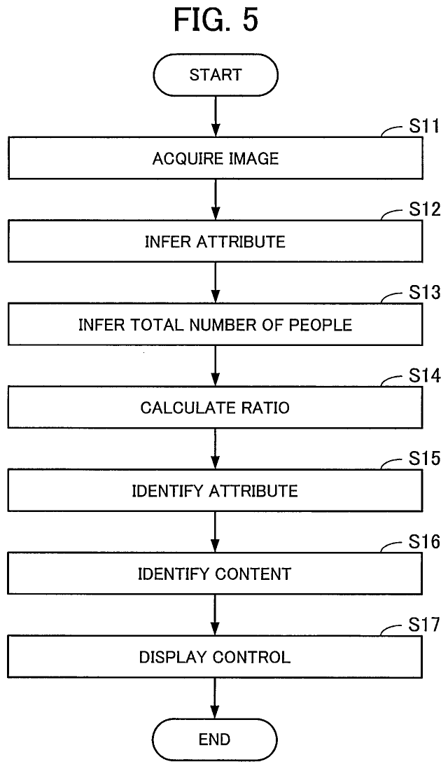

FIG. 5 is a flowchart showing an example of the process executed by the information processing device in the first embodiment.
(Step S11) The acquisition unit 120 acquires an image including a plurality of users.
(Step S12) The inference calculation unit 130 infers an attribute of the plurality of users based on the image.
(Step S13) The inference calculation unit 130 infers the total number of people based on the image.
(Step S14) The inference calculation unit 130 calculates the ratio of each attribute by using the number of people having the inferred attribute and the total number of people.
(Step S15) The identification unit 140 identifies one attribute based on the ordinal ranks corresponding to the ratio of each attribute.
(Step S16) The identification unit 140 identifies content corresponding to the identified attribute based on the facility table 111.
(Step S17) The control unit 150 executes the control for making the display device 300 display the identified content.

According to the first embodiment, the information processing device 100 identifies an attribute at a high ratio among a plurality of attributes corresponding to a plurality of users and provides content corresponding to the identified attribute. Therefore, the provided content attracts interest of a lot of users. Accordingly, the information processing device 100 is capable of providing content that attracts interest.

Further, the identification unit 140 may identify two or more top attributes in the ordinal ranks corresponding to the ratio of each attribute. For example, the identification unit 140 identifies the attribute “male” and the attribute “30's” that are the top two attributes. Then, the identification unit 140 identifies content corresponding to the identified attributes based on the facility table 111. By this, the identification unit 140 identifies the content C1, for example. As above, the information processing device 100 is capable of making the display device 300 display more appropriate content by narrowing down the attributes to be identified.

The identification unit 140 may identify the congestion level corresponding to the identified content based on the facility table 111. For example, when the content A1 has been identified, the identification unit 140 identifies the congestion level A of the facility A. The control unit 150 executes control for making the display device 300 display the identified content and the identified congestion level. Accordingly, the display device 300 displays the content and the congestion level. For example, the display device 300 displays the content A1 and the congestion level A. By the displaying of the congestion level by the display device 300, the information processing device 100 is capable of providing beneficial information to the users.

When a plurality of pieces of content have been identified, the identification unit 140 may identify the congestion level corresponding to each of a plurality of facilities in the plurality of pieces of content based on the facility table 111. The control unit 150 executes control for making the display device 300 display the plurality of pieces of content in ascending order of the congestion level. Accordingly, the display device 300 displays the content in ascending order of the congestion level. The users can easily recognize facilities with low congestion levels.

The identification unit 140 may identify the congestion level corresponding to the identified content based on the facility table 111. For example, when the content A1 has been identified, the identification unit 140 identifies the congestion level A of the facility A. When the congestion level is less than or equal to a predetermined threshold value, the control unit 150 executes control for making the display device 300 display the identified content. Accordingly, the display device 300 displays content of a facility with a low congestion level. Thus, the information processing device 100 is capable of guiding users to a facility with a low congestion level. Further, when the congestion level is higher than the threshold value, the control unit 150 does not execute the content display control. Accordingly, the users become less likely to go to a facility with a high congestion level.

Further, the information processing device 100 may execute the following process. The identification unit 140 identifies one attribute based on the ordinal ranks corresponding to the ratio of each attribute. For example, the identification unit 140 identifies an attribute whose ordinal rank is No. 1. The identification unit 140 identifies facilities corresponding to the identified attribute based on the facility table 111. The identification unit 140 identifies a facility with the greatest number of users among the identified facilities. The identification unit 140 identifies content corresponding to the identified attribute out of content corresponding to the identified facility (i.e., the facility with the greatest number of users) based on the facility table 111. The control unit 150 executes control for making the display device 300 display the identified content. Accordingly, the display device 300 displays content of a facility most frequently used by users having the identified attribute. Thus, the information processing device 100 is capable of providing content that attracts interest of users having the identified attribute.

### Second Embodiment

Next, a second embodiment will be described below. In the second embodiment, the description will be given mainly of features different from those in the first embodiment. In the second embodiment, the description is omitted for features in common with the first embodiment.

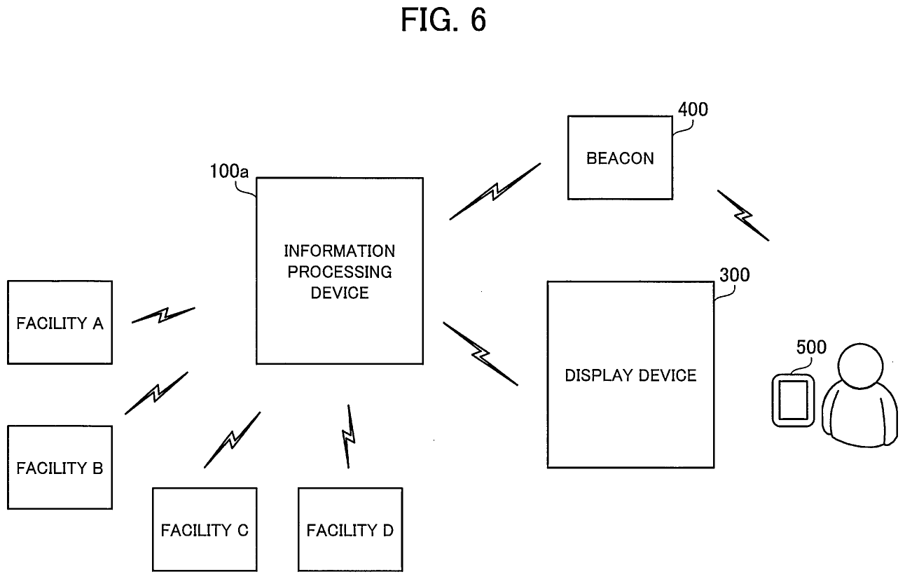

FIG. 6 is a diagram showing an information provision system in the second embodiment. The information provision system includes an information processing device 100a, the display device 300 and a beacon 400. The information processing device 100a, the display device 300 and the beacon 400 execute communication via a network. The network is a wired network or a wireless network. Further, the information processing device 100a executes communication with a terminal device 500 via a network.

The beacon 400 may exist in the vicinity of the display device 300.

A user has the terminal device 500. The terminal device 500 stores a user identifier (ID) of the user. The user ID is referred to also as identification information capable of identifying the user. The identification information can be the name of the user. The user ID in the following description may be replaced with the name of the user.

Next, functions of the information processing device 100a will be described below.

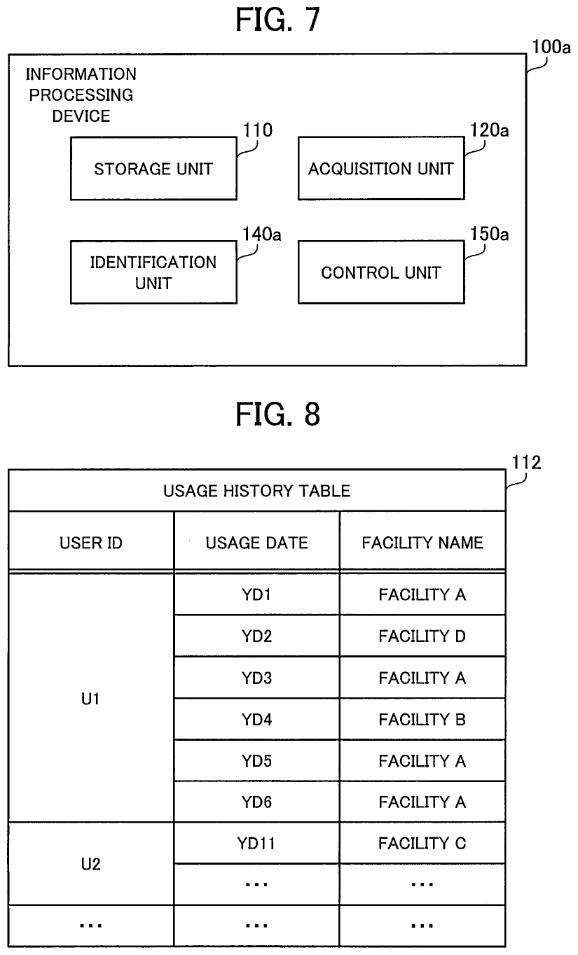

FIG. 7 is a block diagram showing the functions of the information processing device in the second embodiment. The information processing device 100a includes an acquisition unit 120a, an identification unit 140a and a control unit 150a.

The acquisition unit 120a may acquire the user ID stored in the terminal device 500 via the beacon 400. The storage unit 110 may store user attribute information indicating an attribute of the user. For example, the attribute can be sex, age or the like. The acquisition unit 120a may acquire the user attribute information from the storage unit 110 based on the user ID.

Further, the acquisition unit 120a may acquire the user ID and the user attribute information from an external device. For example, the external device stores the user attribute information. The external device acquires the user ID stored in the terminal device 500 via the beacon 400. The external device acquires the user attribute information based on the user ID. The external device transmits the user ID and the user attribute information to the information processing device 100a. By this process, the acquisition unit 120a can acquire the user ID and the user attribute information.

Here, the storage unit 110 may store a usage history table. The usage history table will be shown below.

FIG. 8 is a diagram showing an example of the usage history table in the second embodiment. For example, the usage history table 112 is stored in the storage unit 110. The usage history table 112 is referred to also as usage history information. The usage history table 112 includes items of user ID, usage date and facility name.

In the item of user ID, the user ID is registered. In the item of usage date, the date of usage is registered. In other words, in the item of usage date, the date of visit is registered. In the item of facility name, the name of a facility used by the user is registered.

The acquisition unit 120a acquires the usage history table 112 from the storage unit 110 or an external device.

The identification unit 140a identifies facilities corresponding to the user ID based on the usage history table 112 and the user ID. In short, the identification unit 140a identifies facilities used by the user having the user ID. For example, when the user ID is “U1”, the identification unit 140a identifies facilities A, B and D. The identified facilities are referred to also as second facilities.

The identification unit 140a identifies facilities corresponding to the attribute indicated by the user attribute information based on the facility table 111. For example, when the attribute indicated by the user attribute information is male, the identification unit 140a identifies facilities A, C and D corresponding to males. The identified facilities are referred to also as first facilities.

The identification unit 140a compares the facilities identified based on the facility table 111 with the facilities identified based on the usage history table 112 and identifies a facility that the user having the user ID has never been to out of the facilities identified based on the facility table 111. For example, the identification unit 140a compares the facilities A, C and D with the facilities A, B and D and identifies the facility C that the user having the user ID “U1” has never been to out of the facilities A, C and D.

The identification unit 140a identifies content corresponding to the attribute indicated by the user attribute information out of content corresponding to the identified facility based on the facility table 111. For example, when the identified facility is the facility C and the attribute indicated by the user attribute information is male, the identification unit 140a identifies the content C1.

The control unit 150a executes control for making the terminal device 500 display the identified content. For example, the control unit 150a transmits the identified content and a display command regarding the content to the terminal device 500. Accordingly, the terminal device 500 displays the content.

Further, the control unit 150a may execute control for making the display device 300 display the identified content.

Next, a process executed by the information processing device 100a will be described below by using a flowchart.

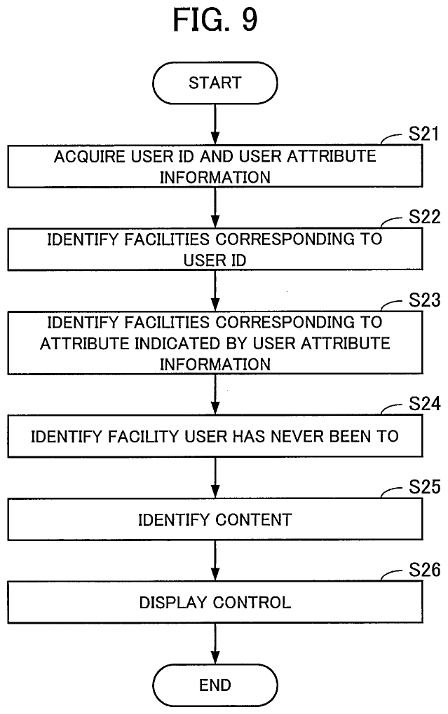

FIG. 9 is a flowchart showing an example of the process executed by the information processing device in the second embodiment.
(Step S21) The acquisition unit 120a acquires the user ID and the user attribute information.
(Step S22) The identification unit 140a identifies facilities corresponding to the user ID by using the usage history table 112.
(Step S23) The identification unit 140a identifies facilities corresponding to the attribute indicated by the user attribute information based on the facility table 111.
(Step S24) The identification unit 140a compares the facilities identified based on the facility table 111 with the facilities identified based on the usage history table 112 and identifies a facility that the user having the user ID has never been to out of the facilities identified based on the facility table 111.
(Step S25) The identification unit 140a identifies content corresponding to the attribute indicated by the user attribute information out of content corresponding to the identified facility based on the facility table 111.
(Step S26) The control unit 150a executes the control for making the terminal device 500 display the identified content.

According to the second embodiment, the information processing device 100a provides content of a facility that the user has never been to. The facility corresponding to the content is a facility that the user has never been to. Therefore, it can be said that the user has interest in the content when the content is provided. Further, the content is content identified based on the attribute indicated by the user attribute information. Therefore, it can be said that the content is content that attracts interest of users having the attribute. Accordingly, the information processing device 100a is capable of providing content that attracts interest.

### Modification of Second Embodiment

The acquisition unit 120a acquires the user attribute information. The user attribute information is acquired by the above-described method. The acquisition unit 120a acquires the facility table 111.

The identification unit 140a identifies facilities corresponding to the attribute indicated by the user attribute information based on the facility table 111. For example, when the attribute indicated by the user attribute information is male, the identification unit 140a identifies facilities A, C and D corresponding to males.

The identification unit 140a identifies a facility with a greatest number of users among the identified facilities. For example, the identification unit 140a identifies the facility A.

The identification unit 140a identifies content corresponding to the attribute indicated by the user attribute information out of content corresponding to the identified facility (i.e., the facility with the greatest number of users) based on the facility table 111. For example, when the attribute is male, the identification unit 140a identifies the content A1.

The control unit 150a executes control for making the terminal device 500 display the identified content. Further, the control unit 150a may execute control for making the display device 300 display the identified content.

Next, a process executed by the information processing device 100a will be described below by using a flowchart.

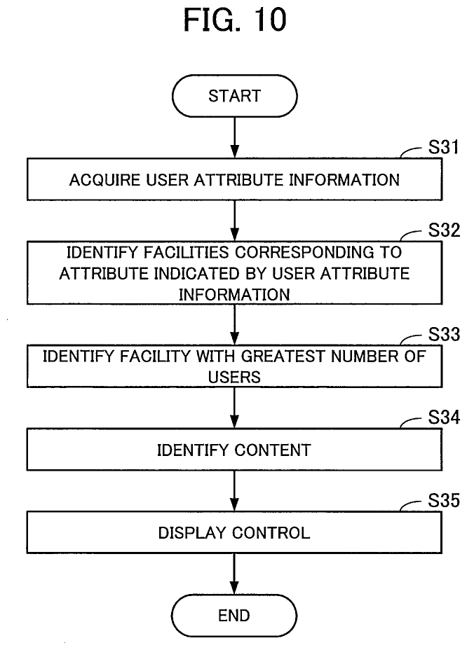

FIG. 10 is a flowchart showing an example of the process executed by the information processing device in the modification of the second embodiment.
(Step S31) The acquisition unit 120a acquires the user attribute information.
(Step S32) The identification unit 140a identifies facilities corresponding to the attribute indicated by the user attribute information based on the facility table 111.
(Step S33) The identification unit 140a identifies a facility with a greatest number of users among the identified facilities.
(Step S34) The identification unit 140a identifies content corresponding to the attribute indicated by the user attribute information out of content corresponding to the identified facility based on the facility table 111.
(Step S35) The control unit 150a executes the control for making the terminal device 500 display the identified content.

According to the modification of the second embodiment, content of a facility most frequently used by users having the attribute indicated by the user attribute information is displayed by the terminal device 500. Accordingly, the information processing device 100a is capable of providing content that attracts interest.

### Third Embodiment

Next, a third embodiment will be described below. In the third embodiment, the description will be given mainly of features different from those in the first and second embodiments. In the third embodiment, the description is omitted for features in common with the first and second embodiments.

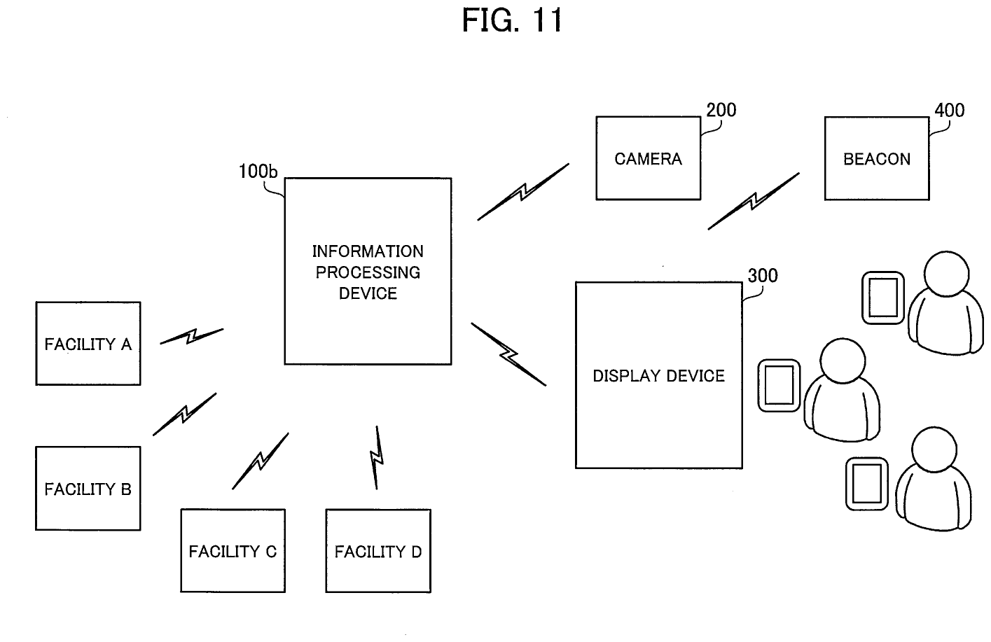

FIG. 11 is a diagram showing an information provision system in the third embodiment. The information provision system includes an information processing device 100b, the camera 200, the display device 300 and the beacon 400. The camera 200 photographs a plurality of users. A plurality of users exists in the vicinity of the display device 300. Each of the plurality of users has a terminal device.

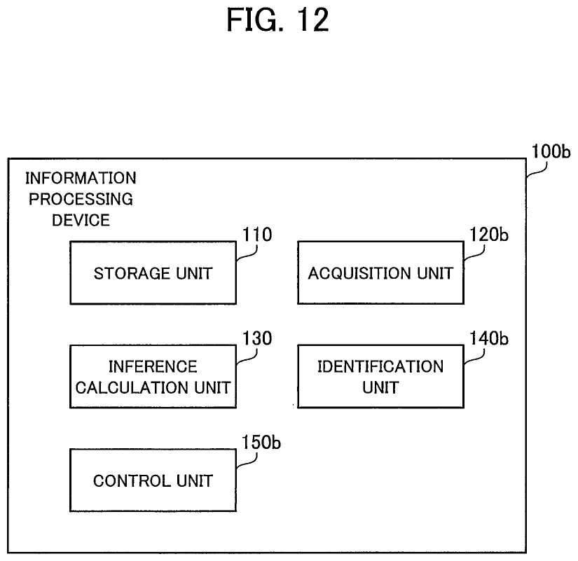

FIG. 12 is a block diagram showing functions of the information processing device in the third embodiment. The information processing device 100b includes the storage unit 110, an acquisition unit 120b, the inference calculation unit 130, an identification unit 140b and a control unit 150b.

The acquisition unit 120b acquires ratio information indicating the ratio of each attribute obtained based on an image obtained by photographing a plurality of users. For example, the acquisition unit 120b acquires the ratio information calculated by the inference calculation unit 130. Alternatively, for example, the acquisition unit 120b acquires the ratio information from the external device.

The identification unit 140b identifies one attribute based on the ordinal ranks corresponding to the ratio of each attribute. For example, the identification unit 140b identifies an attribute whose ordinal rank is No. 1. It is desirable for the identification unit 140b to identify an attribute whose ordinal rank is high.

The identification unit 140b identifies facilities corresponding to the identified attribute based on the facility table 111. The identified facilities are referred to also as first facilities.

The acquisition unit 120b acquires a plurality of user IDs from a plurality of terminal devices that a plurality of users has via the beacon 400. The plurality of user IDs are referred to also as a plurality of pieces of identification information capable of identifying the plurality of users.

The identification unit 140b identifies facilities corresponding to the plurality of user IDs based on the usage history table 112 and the plurality of user IDs. In short, the identification unit 140b identifies facilities used by the plurality of users. The identified facilities are referred to also as second facilities.

The identification unit 140b compares the facilities identified based on the facility table 111 with the facilities identified based on the usage history table 112 and identifies a facility least frequently used by the plurality of users corresponding to the plurality of user IDs out of the facilities identified based on the facility table 111.

The identification unit 140b identifies content corresponding to the identified attribute out of content corresponding to the identified facility based on the facility table 111.

The control unit 150b executes control for making the display device 300 display the identified content.

Next, a process executed by the information processing device 100b will be described below by using a flowchart.

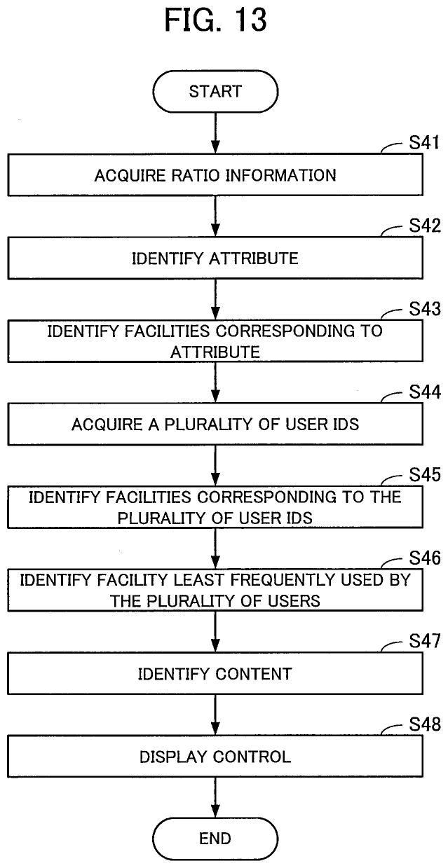

FIG. 13 is a flowchart showing an example of the process executed by the information processing device in the third embodiment.
(Step S41) The acquisition unit 120b acquires the ratio information indicating the ratio of each attribute.
(Step S42) The identification unit 140b identifies one attribute based on the ordinal ranks corresponding to the ratio of each attribute.
(Step S43) The identification unit 140b identifies facilities corresponding to the identified attribute based on the facility table 111.
(Step S44) The acquisition unit 120b acquires a plurality of user IDs from a plurality of terminal devices that a plurality of users has via the beacon 400.
(Step S45) The identification unit 140b identifies facilities corresponding to the plurality of user IDs by using the usage history table 112.
(Step S46) The identification unit 140b compares the facilities identified based on the facility table 111 with the facilities identified based on the usage history table 112 and identifies a facility least frequently used by the plurality of users corresponding to the plurality of user IDs out of the facilities identified based on the facility table 111.
(Step S47) The identification unit 140b identifies content corresponding to the identified attribute out of content corresponding to the identified facility based on the facility table 111.
(Step S48) The control unit 150b executes the control for making the display device 300 display the identified content.

According to the third embodiment, the information processing device 100b provides content of a facility that a lot of users have never used. The facility corresponding to the content is a facility that a lot of users have never used. Therefore, it can be said that a lot of users have interest in the content when the content is provided. Further, the content is content identified based on an attribute corresponding to a plurality of users. Therefore, it can be said that the content is content that attracts interest of users having the attribute. Accordingly, the information processing device 100b is capable of providing content that attracts interest.

### Modification of Third Embodiment

In the third embodiment, the description was given of the case where content of a facility that a lot of users have never used is provided. In a modification of the third embodiment, a description will be given of a case where content of a facility most frequently used by a plurality of users is provided.

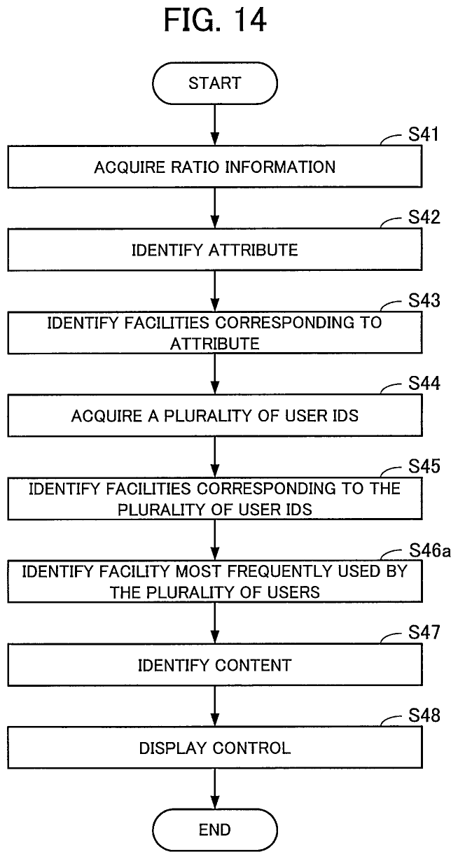

FIG. 14 is a flowchart showing an example of a process executed by an information processing device in the modification of the third embodiment. The process in FIG. 14 differs from the process in FIG. 13 in that step S46a is executed. Thus, the step S46a will be described below with reference to FIG. 14. Then, the description will be omitted for processing other than the step S46a.

(Step S46a) The identification unit 140b compares the facilities identified based on the facility table 111 with the facilities identified based on the usage history table 112 and identifies a facility most frequently used by the plurality of users corresponding to the plurality of user IDs out of the facilities identified based on the facility table 111.

According to the modification of the third embodiment, the information processing device 100b provides content of a facility used by a lot of users. The content is content of a facility used by a lot of users having the identified attribute. Therefore, it can be said that the content is content that attracts interest of a lot of users. Accordingly, the information processing device 100b is capable of providing content that attracts interest.

### Fourth Embodiment

Next, a fourth embodiment will be described below. In the fourth embodiment, the description will be given mainly of features different from those in the first to third embodiments. In the fourth embodiment, the description is omitted for features in common with the first to third embodiments.

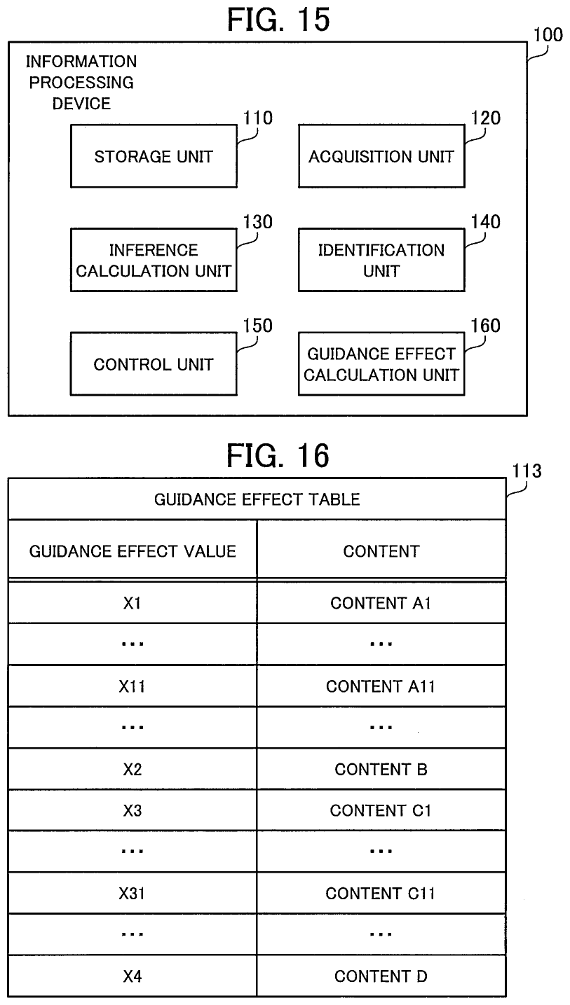

FIG. 15 is a block diagram showing functions of an information processing device in the fourth embodiment. The information processing device 100 further includes a guidance effect calculation unit 160.

Here, the information processing device 100 provides content to the display device 300, by which the display device 300 is made to display the content. The display device 300 displays the content, by which a visual recognition rate is obtained. Incidentally, calculation of the visual recognition rate may be executed by a device such as the display device 300.

The acquisition unit 120 acquires the visual recognition rate. For example, the acquisition unit 120 acquires the visual recognition rate from a device that calculated the visual recognition rate.

Further, the acquisition unit 120 acquires a first congestion level, as the congestion level of a facility corresponding to the content before the content is displayed, from a device installed in the facility. The acquisition unit 120 acquires a second congestion level, as the congestion level of the facility corresponding to the content after the content is displayed, from the device installed in the facility.

The guidance effect calculation unit 160 calculates a congestion level increase ratio based on the first congestion level and the second congestion level. The guidance effect calculation unit 160 calculates a guidance effect value by using expression (1). Incidentally, α is a constant.

$$guidance effect value = congestion level increase ratio + α \times visual recognition rate \qquad ( 1 )$$

Here, the content is provided to the terminal device 500, by which the terminal device 500 is made to display the content. After the content is displayed by the terminal device 500, the user clicks on content in which the user had interest. The terminal device 500 calculates a click ratio based on the number of pieces of displayed content and the number of pieces of content clicked on.

The acquisition unit 120 may acquire the click ratio from the terminal device 500. The guidance effect calculation unit 160 may also calculate the guidance effect value by using expression (2).

$$guidance effect value = congestion level increase ratio + α \times click ratio \qquad ( 2 )$$

Further, when the user goes to the facility corresponding to the content, the acquisition unit 120 may acquire a success rate from the terminal device 500. When the success rate is acquired, the guidance effect calculation unit 160 may calculate the guidance effect value by using expression (3). Incidentally, β is a constant.

$$guidance effect value = congestion level increase ratio + α \times click ratio + β \times success rate \qquad ( 3 )$$

The guidance effect value is calculated as above. Incidentally, it is permissible even if the calculation of the guidance effect value is executed by a device other than the information processing device 100. The guidance effect value is referred to also as a value indicating a guidance effect of guiding to a facility.

For example, the storage unit 110 stores a guidance effect table indicating correspondence relationship between the guidance effect value and content. An example of the guidance effect table will be shown below.

FIG. 16 is a diagram showing an example of the guidance effect table in the fourth embodiment. For example, the guidance effect table 113 is stored in the storage unit 110. The guidance effect table 113 is referred to also as guidance effect information. The guidance effect table 113 indicates the correspondence relationship between the guidance effect value and content. Incidentally, it is permissible even if the guidance effect table 113 is stored in a device other than the information processing device 100.

The acquisition unit 120 acquires the guidance effect table 113. For example, the acquisition unit 120 acquires the guidance effect table 113 from the storage unit 110.

After identifying the content corresponding to the attribute, the identification unit 140 identifies content based on the guidance effect value corresponding to the identified content. For example, the identification unit 140 identifies content whose guidance effect value is the highest. Alternatively, for example, the identification unit 140 identifies content whose guidance effect value is the second highest. As above, it is desirable for the identification unit 140 to identify content whose guidance effect value is high.

The control unit 150 executes control for making the display device 300 display the identified content.

According to the fourth embodiment, the information processing device 100 is capable of providing content having great guidance effect.

The above description has been given of the case where content having great guidance effect is provided by using the case in the first embodiment. Also in the cases in the second embodiment, the modification of the second embodiment, the third embodiment, and the modification of the third embodiment, the information processing device 100a, 100b is similarly capable of providing content having great guidance effect.

Here, the information processing device 100 may execute communication with the terminal device 500. Then, the information processing device 100 may execute the following process. The acquisition unit 120 acquires the user attribute information, the facility table 111 and the guidance effect table 113. The identification unit 140 identifies content corresponding to the attribute indicated by the user attribute information based on the facility table 111. The identification unit 140 identifies content based on the guidance effect value corresponding to the identified content. The control unit 150 executes control for making the terminal device 500 display the identified content. As above, the information processing device 100 provides content having great guidance effect. Accordingly, the information processing device 100 is capable of providing content that attracts interest.

Features in the embodiments described above can be appropriately combined with each other.

### DESCRIPTION OF REFERENCE CHARACTERS

100: information processing device, 100a: information processing device, 100b: information processing device, 101: processor, 102: volatile storage device, 103: nonvolatile storage device, 110: storage unit, 111: facility table, 112: usage history table, 113: guidance effect table, 120:

acquisition unit, 120a: acquisition unit, 120b: acquisition unit, 130: inference calculation unit, 140: identification unit, 140a: identification unit, 140b: identification unit, 150: control unit, 150a: control unit, 150b: control unit, 160: guidance effect calculation unit, 200: camera, 300: display device, 400: beacon, 500: terminal device

What is claimed is:

1. An information processing device that executes communication with a display device, the information processing device comprising:
acquiring circuitry to acquire ratio information that indicates a ratio of each attribute corresponding to a plurality of users existing in a vicinity of the display device, facility information indicating correspondence relationship among a facility, content and an attribute, a plurality of pieces of identification information capable of identifying the plurality of users and usage history information indicating facilities used by the plurality of users;
identifying circuitry to identify one attribute based on ordinal ranks corresponding to the ratio of each attribute, identify first facilities as facilities corresponding to the identified attribute based on the facility information, identify second facilities as facilities used by the plurality of users based on the usage history information and the plurality of pieces of identification information, compare the first facilities with the second facilities, identify a facility least frequently used by the plurality of users or a facility most frequently used by the plurality of users out of the first facilities, and identify content corresponding to the identified attribute out of content corresponding to the identified facility based on the facility information; and
controlling circuitry to execute control for making the display device display the identified content.

2. The information processing device according to claim 1, wherein
the acquiring circuitry acquires guidance effect information indicating correspondence relationship between a guidance effect value indicating a guidance effect of guiding to a facility and content, and
after identifying the content corresponding to the attribute, the identifying circuitry identifies content based on the guidance effect value corresponding to the identified content.

3. A control method performed by an information processing device that executes communication with a display device, the control method comprising:
acquiring ratio information that indicates a ratio of each attribute corresponding to a plurality of users existing in a vicinity of the display device, facility information indicating correspondence relationship among a facility, content and an attribute, a plurality of pieces of identification information capable of identifying the plurality of users and usage history information indicating facilities used by the plurality of users;
identifying one attribute based on ordinal ranks corresponding to the ratio of each attribute, identifying first facilities as facilities corresponding to the identified attribute based on the facility information, and identifying second facilities as facilities used by the plurality of users based on the usage history information and the plurality of pieces of identification information;
comparing the first facilities with the second facilities;
identifying a facility least frequently used by the plurality of users or a facility most frequently used by the plurality of users out of the first facilities;
identifying content corresponding to the identified attribute out of content corresponding to the identified facility based on the facility information; and
executing control for making the display device display the identified content.

4. An information processing device, executing communication with a display device, the information processing device comprising:
a processor to execute a program; and
a memory to store the program which, when executed by the processor, performs processes of,
acquiring ratio information that indicates a ratio of each attribute corresponding to a plurality of users existing in a vicinity of the display device, facility information indicating correspondence relationship among a facility, content and an attribute, a plurality of pieces of identification information capable of identifying the plurality of users and usage history information indicating facilities used by the plurality of users,
identifying one attribute based on ordinal ranks corresponding to the ratio of each attribute, identifying first facilities as facilities corresponding to the identified attribute based on the facility information, and identifying second facilities as facilities used by the plurality of users based on the usage history information and the plurality of pieces of identification information,
comparing the first facilities with the second facilities,
identifying a facility least frequently used by the plurality of users or a facility most frequently used by the plurality of users out of the first facilities,
identifying content corresponding to the identified attribute out of content corresponding to the identified facility based on the facility information, and
executing control for making the display device display the identified content.
